(19) United States
(12) Patent Application Publication
(10) Pub. No.: US 2026/0269497 A1
(43) Pub. Date: Sep. 10, 2026

(54) HIGH PERFORMANCE CONNECTOR WITH BGA SIGNAL ATTACHMENT

(71) Applicant: Amphenol Corporation, Wallingford, CT (US)

(72) Inventors: Lewis Robin Johnson, York, PA (US); Stephen B. Smith, Mechanicsburg, PA (US); Benjamin Reed Staudt, Harrisburg, PA (US); Mark R. Gray, York, PA (US); Jason John Ellison, Dillsburg, PA (US)

(73) Assignee: Amphenol Corporation, Wallingford, CT (US)

(21) Appl. No.: 18/875,675

(22) PCT Filed: Jun. 16, 2023
(86) PCT No.: PCT/US2023/025538

§ 371 Date: Dec. 16, 2024

Related U.S. Application Data
(60) Provisional application No. 63/353,454, filed on Jun. 17, 2022.

(51) Int. Cl. H01R 12/71; H01R 12/57; H01R 12/58; H01R 12/70; H01R 12/73; H01R 13/6587; H01R 13/6595

(52) U.S. Cl. CPC H01R 12/716; H01R 12/57; H01R 12/58; H01R 12/707; H01R 12/73; H01R 13/6587; H01R 13/6595

(57) ABSTRACT

A connector configured for BGA attachment of terminals to pads on a PCB and coupling of planar conductive elements at the mounting interface without the use of solder balls in addition to those coupling the terminals to the PCB. Projections from the conductive elements may be fused to the same solder balls connecting one or more terminals to the PCB or may be coupled to ground structures on the PCB using a different attachment technique. The projections, for example, may be J-leads that are attached to pads on the PCB using surface mount soldering or may be pins that are attached within holes of the PCB using pin in paste mounting techniques. The PCB may have columns of signal pads configured for electrical connection to signal terminals of the connector using BGA termination techniques with holes between adjacent columns to receive pins of a shield of the connector.

### CROSS-REFERENCE TO RELATED APPLICATIONS

This application claims priority to and the benefit under 35 U.S.C. § 119(e) of U.S. Provisional Application Ser. No. 63/353,454, filed on Jun. 17, 2022, entitled “HIGH PERFORMANCE CONNECTOR WITH BGA SIGNAL ATTACHMENT.” The contents of this application are incorporated herein by reference in its entirety.

### TECHNICAL FIELD

This patent application relates generally to BGA connectors and more specifically to high speed BGA connectors.

### BACKGROUND

Separable electrical connectors are used in many electronic systems to connect subassemblies. Integrating subassemblies into a device using electrical connectors can be simply accomplished by pressing the subassemblies together such that the separable connectors mate. Manufacturing an electronic system in this way can provide multiple benefits. Each subassembly may be manufactured by a company that specializes in the functionality provided by that subassembly, such that the subassemblies might deliver higher performance or quality than comparable electronic circuitry of a full device manufactured by a single company. Further, subassemblies enable the device to be maintained over its lifetime, as subassemblies may be added or replaced to repair or upgrade the electronic system.

A server, for example, may be assembled from two or more subassemblies. Each electronic subassembly may be formed by attaching components to a printed circuit board. One subassembly may be the server motherboard. The motherboard may be a printed circuit board that makes connections between components, such as a processor, memory, power, and a network interface, that operate together to provide the server functionality. Some of the components may be mounted to the motherboard, but others may be mounted to other printed circuit boards, often call daughter boards. The daughtercard subassemblies may be connected to the motherboard through separable connectors.

Connectors are configured to mount to printed circuit boards (PCBs) with a desired orientation within a device. The daughter cards may be mounted, for example, with edges facing edges of the motherboard. A connector configured for mounting of subassemblies in this configuration may be configured as a right angle or an orthogonal connector. Alternatively, a daughtercard may be mounted with its surface parallel to the surface of the motherboard. Mezzanine connectors are configured for connecting parallel subassemblies. In a server, for example, a processor may be attached to a daughter card and attached to a motherboard through a mezzanine connector.

Various attachment techniques are used the make electrical and mechanical connections between a connector and a PCB to which the connector is mounted. Some connectors, for example, are mounted to a printed circuit board with through hole soldering. According to this technology, a tail of a conductive element such as a signal conductor passing through a connector, is inserted through a hole in the printed circuit board. The end of the tail is dipped in molten solder, which wicks up the contact tail to fill space in the hole around the tail. The hole passes through conductors within the printed circuit board, such that when the solder in the hole solidifies, it both mechanically locks the tail in the hole and makes electrical connection between the tail and the conductive structures within the PCB.

A variation on plated through hole technology is called pin in paste attachment. In this case, a pin extending from a conductive element in a connector is inserted into solder paste that has been applied to a conductive surface of the PCB. The PCB is then placed in a solder reflow oven, causing the solder paste to liquify. The molten solder adheres to both the pin and conductive surface on the PCB such that when the solder solidifies, the pin is electrically and mechanically connected to that conductive surface on the PCB. For pin and paste attachment, the pin is often inserted into a hole in the PCB, which has a conductive inner surface. The hole may extend fully or partially through the PCB. Upon reflow the solder may wick into the hole and adhere to conductive structures within the hole as well as to the pin.

Electrical connectors may also be mounted to a PCB using surface mount soldering. With surface mount soldering, portions of the tails of the conductive elements in the connector are aligned parallel to conductive pads on a surface of the PCB. Solder paste may be placed on these pads, with the tails resting on the paste. When this PCB is placed in a reflow oven, the solder paste may melt, producing molten solder in contact with the tail and the conductive pads, electrically and mechanically attaching the connector to the PCB. For a vertical connector, the tails may extend from the connector in a direction generally perpendicular to the surface of the board and may bend at their tips to create a portion parallel to the surface of the board. Tails in this configuration are sometimes said to have a J-lead configuration.

A further attachment technique involves solder balls attachment, sometimes referred to as BGA attachment. For a BGA attachment, tails of the conductive elements within the connector are exposed at a mounting interface of the connector. Solder balls may be attached to the tails, which may be achieved by heating the solder to sufficiently liquify it that it adheres to the tail. For attaching the connector to a PCB, the connector may be placed on the PCB with solder balls aligned with pads on the surface of the PCB. When the PCB is heated in reflow oven, the solder balls melt such that the solder adheres to the pads as well as the tails, such that when the solder cools, the tails are affixed to the pads through the solder.

As electronic systems have gotten smaller, faster, and more complex, the number of circuits in a given area of an electronic system, along with the frequencies at which the circuits operate, have increased significantly in recent years. Current systems pass more data between PCBs and require electrical connectors that are electrically capable of handling more data at higher speeds than connectors of even a few years ago. The integrity of signals passing through a separable connector, however, is often negatively impacted with greater densities and higher frequencies such that it can be challenging to design a connector for both high speed signals and high densities.

### SUMMARY

Concepts as described herein may be embodied as a mezzanine connector comprising: a housing having a first side and a second side, opposite the first side; a plurality of columns of terminals held within the housing, each of the plurality of terminals comprising a tail; a plurality of solder balls, each of the plurality of solder balls attached to a tail of a respective terminal of the plurality of terminals adjacent to the first side of the housing; and a plurality of conductive members, each of the plurality of conductive members extending perpendicular to the first side of the housing and parallel to and adjacent to at least one respective column of the plurality of columns of terminals. Each of the plurality of conductive members may comprise a plurality of projections, each of the plurality of projections configured for connection to a ground structure of a printed circuit board via solder when the mezzanine connector is mounted to a surface of the printed circuit board.

In another aspect, concepts as described herein may be embodied as an electrical connector comprising a plurality of terminal subassemblies. Each of the plurality of terminal subassemblies may comprise an insulative portion having a first side; a column comprising a plurality of terminals held within the insulative portion; a plurality of solder balls coupled to respective ones of the tails of the plurality of terminals at the first side; and at least one planar conductive member extending parallel to the column, wherein the planar conductive member comprises a plurality of projections, extending from the planar conductive member adjacent the first side. Each of the plurality of terminals may comprise a tail extending from the insulative portion at the first side, a mating contact portion extending from the insulative portion and an intermediate portion, joining the tail and the mating contact portion. For each of the plurality of terminals, the intermediate portion may be held by the insulative portion.

In another aspect, concepts as described herein may be embodied as an electronic assembly comprising a printed circuit board, which may comprise a surface; a plurality of pads on the surface; and a ground structure within the printed circuit board. The electronic assembly may additionally comprise a connector mounted to the surface. The connector may comprise a housing comprising a side facing the surface of the printed circuit board; a plurality of terminals held by the housing, each terminal of the plurality of terminals comprising a tail; a plurality of solder masses between the housing and the surface of the printed circuit board, wherein at least a subset of the plurality of solder masses are attached to the tails of the plurality of terminals so as to couple tails of the plurality of terminals to respective pads of the plurality of pads; and a plurality of conductive members mechanically coupled to the housing and disposed between at least the tails of sets of terminals of the plurality of terminals. The plurality of conductive members each may comprise a plurality of projections extending into the space between the side of the housing and the surface of the printed circuit board. The plurality of projections may be electrically coupled to the ground structure within the printed circuit board through solder masses of the plurality of solder masses.

In another aspect, concepts as described herein may be embodied as a connector configured to be electrically coupled to a printed circuit board (PCB) with a hybrid attachment. The connector may comprise a first and second plurality of signal terminals, wherein the first and second plurality of signal terminals are configured to be electrically connected to traces of a PCB using solder balls so as to form a ball gate array (BGA) termination; and a shield between the first and second plurality of signal terminals, wherein the shield comprises one or more pins configured to be inserted into one or more holes of the PCB.

These techniques may be used alone or in any suitable combination. The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a perspective view of mating connectors configured as BGA mezzanine connectors.

FIG. 1B is a partial cross section through the connectors of FIG. 1A in a mated configuration.

FIGS. 2A and 2B are a side view and an end view, respectively, of an exemplary terminal subassembly, mounted to a PCB using a hybrid termination technique, according to some embodiments.

FIGS. 3A, 3B, 3C and 3D show a top, first side, bottom, and end view of the terminal subassembly of FIGS. 2A and 2B, according to some embodiments.

FIG. 4 is a perspective view of the terminal subassembly of FIGS. 2A and 2B, according to some embodiments.

FIG. 5 is a perspective view of the PCB of FIGS. 2A-B, according to some embodiments.

FIG. 6 is a perspective view of an alternative PCB configuration to which a connector using a hybrid termination technique may be mounted, according to some embodiments.

FIG. 7 is a side view of a terminal subassembly mounted to the PCB of FIG. 6 using a hybrid termination technique, according to some embodiments.

FIGS. 8A and 8B are a side perspective view and an end view of a terminal subassembly configured for mounting to a PCB using a hybrid termination technique, according to some embodiments.

FIG. 8C is an end perspective view of a plurality of terminal subassemblies formed using construction techniques described in connection with FIGS. 8A and 8B, held together as a first connector, mated to a second connector comprising a plurality of like terminal subassemblies, with pins extending from each connector cut away in a plane corresponding to a surface of a PCB to which the connector is mounted;

FIG. 8D is a cross section through the mated first connector and second connector of FIG. 8C at a first location, passing through a solid section of the shields of the terminal subassemblies;

FIG. 8E is a cross section through the mated first connector and second connector of FIG. 8C at a second location, passing through openings of the shields of the terminal subassemblies.

FIG. 9 is a sketch of a portion of a connector footprint on a PCB to which a connector using a hybrid termination technique is attached, according to some embodiments.

FIGS. 10A and 10B are a top, side perspective view and a bottom, side perspective view, respectively, of a terminal subassembly configured for mounting to a PCB using an alternative hybrid termination technique, according to some embodiments.

FIG. 10C is an enlarged view of the portion of the terminal subassembly labeled 10C in FIG. 10B.

FIG. 11A is an end view of the terminal subassembly in FIG. 10A.

FIG. 11B is an end view of multiple terminal subassemblies as in FIG. 10A, such as in a connector formed from multiple terminal subassemblies, mounted to a printed circuit board.

FIG. 12A is a bottom, side perspective view of an alternative embodiment of a terminal subassembly configured for mounting to a PCB, according to some embodiments.

FIG. 12B is an enlarged view of the portion of the terminal subassembly labeled 12B in FIG. 12A in a manufacturing state in which a first planar conductor is attached and before solder balls are fused to the tails of conductors of the terminal subassembly.

FIG. 12C is an enlarged view of the portion of the terminal subassembly labeled 12B in FIG. 12A in a manufacturing state in which a first and second planar conductors are attached and before solder balls are fused to the tails of terminals.

FIG. 12D is an enlarged cross-section of a ground terminal, in a terminal subassembly as in in FIG. 12A in a manufacturing state in which a first and second planar conductors are attached and solder balls are fused to the tails of the terminal.

### DETAILED DESCRIPTION

The inventors recognized and appreciated techniques for improving high-speed and high-density connectors, enabling them to pass many signals with high integrity in a relatively small area. These techniques may enable the integration of grounded conductors at the mounting interface of the connector without an undesirable impact on density of the connector. The grounded conductors may be generally planar and may reduce crosstalk between signal conductors and/or reduce changes in impedance near the mounting interface of signal terminals, which might cause reflections or other types of signal distortions. These techniques may be used in connectors with BGA attachment for signals, increasing the speed at which these connectors operate, while maintaining a high density of signal connections through a ball grid array. Accordingly, techniques as described herein may be applied to provide high-speed and high-density mezzanine connectors using BGA attachment.

According to techniques described herein, planar conductors at the mounting interface may be connected to ground structures of the PCB to which the connector is mounted without the introduction of mounting locations in addition to those used to attach the terminals of the connector or with only the introduction of additional mounting locations that have a limited impact on signal density at the mounting interface. BGA attachment may be used, for example, for attaching terminals of the connector to a PCB. The added conductors may be connected to ground on the PCB without the addition of solder balls beyond those used to connect the terminals to the PCB.

This result may be achieved, for example, with projections from the planar conductors that extended into the vicinity of tails of ground terminals of the connector. When a solder ball is fused to the tail of the ground terminal, it may be simultaneously fused to the projection of the planar conductor, thereby grounding the planar conductor. Such a technique may have little or no impact on density and yield a high-speed and high-density BGA connector. A high-speed and high-density mezzanine connector that may be readily mounted to a PCB with other BGA components may be readily implemented in this way.

The planar conductors alternatively or additionally may be connected to ground structures in the PCB with an attachment technique that does not require additional solder balls. One way of doing so is by using hybrid termination techniques, such as pin-in-paste or surface mount soldering for the planar conductors in conjunction with ball grid array (BGA) attachment for signal terminals. The planar conductors, for example, may have pins or J-leads extending beyond an edge of the conductor facing a PCB.

The inventors have recognized and appreciated that by using a combination of attachment techniques, electrical performance may be improved because compression of solder balls used for connecting high speed signals may be reduced relative to a connector in which grounded conductors acting as shields are also attached to a PCB with solder balls. Without being bound by any particular theory, the inventors theorize that, during reflow to attach the solder balls to pads on the PCB, the weight of the connector on the molten solder balls may compress them, resulting in solder masses fusing the signal terminals to signal pads on a PCB that have a larger diameter than the original solder balls. This deformation of the solder balls can be exasperated by the added weight of additional planar conductors and can have an undesired impact on impedance at the mounting interface of the connector. This impact may be particularly acute for a high-speed connector in which small diameter solder balls are used for signal terminals to provide a desired impedance. Other attachment techniques described herein, such as pin in paste and/or J lead surface mount, when used in combination with solder ball attachment may provide greater support to the connector during reflow, reducing distortion of the solder masses fusing the signal terminals to the PCB. The high-speed and high-density attachment for signal terminals may nonetheless be retained.

The inventors have also recognized and appreciated that by mixing attachment techniques conductors that act as shields may extend close to or beyond a surface of the PCB, providing highly effective shielding and/or impedance control at the mounting interface. The inventors have recognized and appreciated that without these grounded, planar conductors, the structures of a connector in which signal terminals are connected to pads on a PCB with BGA mounting techniques may have a particularly undesirable impact on signal integrity. Techniques as described herein may enable high-speed performance of a connector with BGA attachment of signal terminals with a high-density mounting interface.

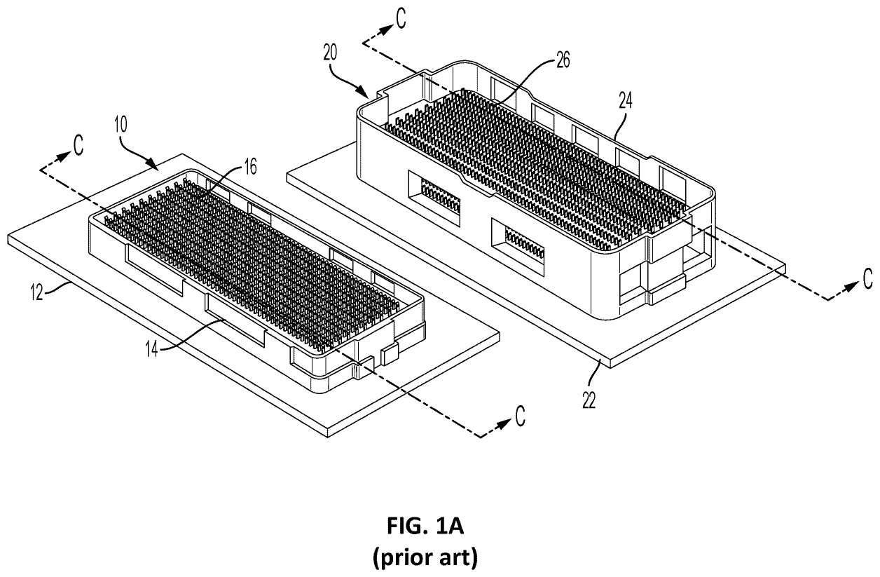

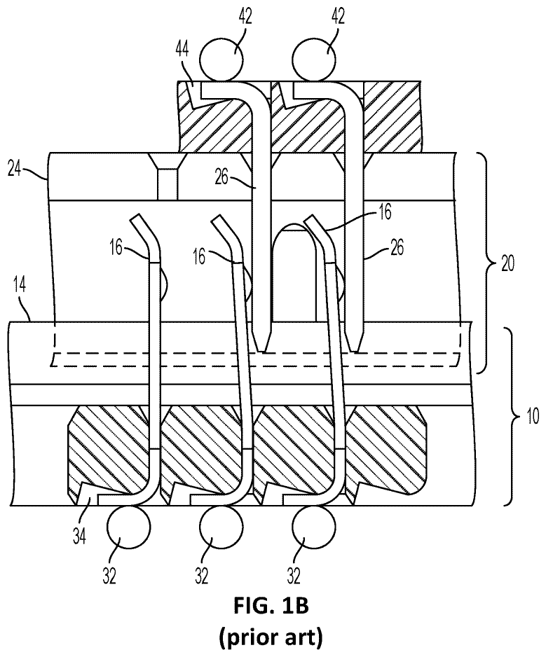

FIGS. 1A and 1B illustrate known mezzanine connectors 10 and 20 mounted to respective PCBs using a BGA attachment technique. In the example of FIG. 1A, connector 10 is mounted to PCB 12 and connector 20 is mounted to PCB 22. Each of the connectors has a housing, which may be made of insulative material. Connector 10 has a housing 14 and connector 20 has a housing 24. In this example, housing 14 is configured to fit within and latch to housing 24, such that connectors 10 and 20 may be pressed together for mating. When mated, connectors 10 and 20 may collectively provide multiple conductive paths between PCB 12 and PCB 22.

Each of the housings 14 and 24 may hold multiple conductive terminals 16 and 26 that make connections through the respective connectors 10 and 20. Each of the terminals 16 and 26 may have a mating contact portion. The mating contact portions of terminals 16 and 26 may be complementary, such that when connectors 10 and 20 mate, a mating contact portion of a terminal 16 may make electrical connection to a mating contact portion of a respective terminal 26. For example, the meeting contact portions of terminal 26 may be shaped as blades, and the mating contact portions of terminals 16 may be shaped as beams. Upon mating, the beams of terminals 16 may deflect, exerting a mating force against the blades of the mating contact portions of terminals 26.

The mating contact portions of the terminals are positioned at the mating interface of each of the connectors. As shown in FIG. 1A, the terminals 16 and 26 are arranged in multiple parallel columns C, such that the mating interface of each connector comprises an array with multiple parallel columns of mating contact portions.

Each of the terminals may have a tail configured for connecting the terminal to another structure, which is the PCB in this example. The tails may extend from a respective housing at the mounting interface of the connector. In this example, the tails of the terminals 16 of connector 10 extend into pockets 34, formed at the mounting side of housing 14. Tails of terminals 26 of connector 20 extend into pockets 44 at the mounting side of housing 24. As shown in the partial cross-section of FIG. 1B, each of the terminals 16 in connector 10 has a tail to which a solder ball 32 has been fused. Each of the terminals 26 in connector 20 has a tail to which a solder ball 42 has been fused. In the example of FIG. 1B, the tails of the terminals are bent such that a surface of the tail is parallel to the mounting interface and the solder balls 32 and 42 are fused to such a surface of the tail of a respective terminal.

A connector, such as connectors 10 or 20 shown in FIGS. 1A and 1B, may be manufactured by molding a housing as a unitary structure with openings into which terminals are inserted. Alternatively, a housing may be formed of multiple components. A connector may be formed, for example, by first forming terminal subassemblies, each of which has multiple terminals held in an insulative portion, which serves as a portion of the connector housing. These terminal subassemblies may then be secured to a support structure such that the terminal subassemblies are held together as a connector. As an example, an insulative frame may be molded with features (such as a slot) that receives ends of the terminal subassemblies such that when the terminal subassemblies are engaged in the frame, the terminals of the terminal subassemblies form multiple parallel columns of terminals. Alternatively or additionally, the terminal subassemblies may be held together by a metal clip or adhered to each other such as via an adhesive or heat staking.

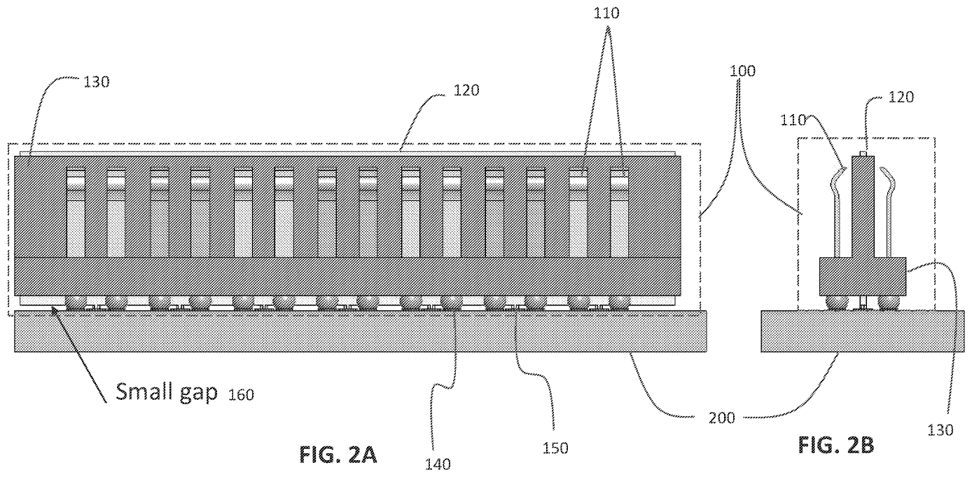

FIGS. 2A and 2B illustrate a portion of a connector, which in this example uses BGA attachment for terminals in the connector. The structure shown in FIGS. 2A and 2B may be repeated to form a connector with multiple parallel columns of terminals, as described above in connection with FIG. 1A. In a connector in which an integral housing is used for multiple columns of terminals, the portion illustrated in FIGS. 2A and 2B may be a portion of the integral housing. In a connector manufactured from multiple terminal subassemblies, the portion illustrated in FIGS. 2A and 2B may be representative of a terminal subassembly, and the housing of the terminal subassembly may be a portion of the connector housing.

For simplicity of explanation, a connector assembled from a plurality of terminal subassemblies is described, but it should be appreciated that the structures described herein may be integrated into a connector using other manufacturing techniques. Accordingly, FIGS. 2A and 2B are views of different sides of an exemplary terminal subassembly mounted to a PCB, showing the left side and end, respectively. The terminal subassembly 100 may be connected to PCB 200 using hybrid techniques. For example, a shield of terminal subassembly 100 may have pins configured to be inserted through holes of the PCB 200 while the terminals are configured to be electrically connected to contact pads on a surface of the PCB 200 using a ball grid array (BGA) attachment technique.

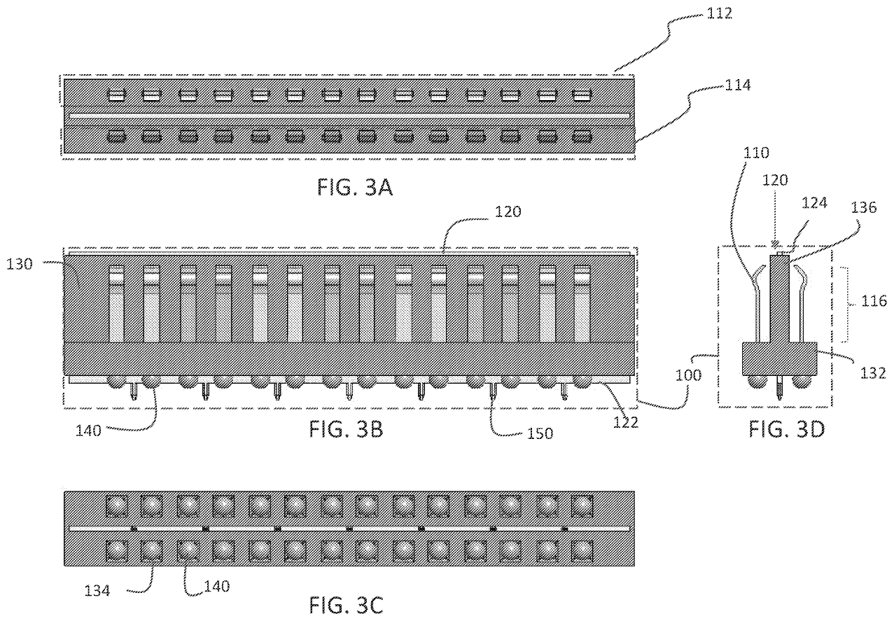

FIGS. 3A, 3B, 3C and 3D are views of different sides of terminal subassembly 100, not mounted to a PCB, showing the top, left side, bottom and end, respectively, according to some embodiments. Terminal subassembly 100 may include a housing 130. Housing 130 may be made of an insulative material, such as nylon or other thermoplastic.

Housing 130 may hold a plurality of terminals. In this example, terminal subassembly 100 has two columns 112 and 114 of terminals. Housing 130 has a base portion 132, in which intermediate portions of terminals 110 are held. Base portion 132 may be molded over the intermediate portions of terminals 110 or terminals 110 may be inserted into openings in base portion 132. Columns 112 and 114 may be separated by a center-to-center distance between 1.5 and 2.5 mm (e.g., 1.8 mm or 2.3 mm).

Mating ends 116 of terminals 110 extend from base portion 132. The mating ends 116 are separated by a wall portion 136 of housing 130. In this example, the mating ends are beams that may deflect to generate a contact force for mating to the mating ends of terminals in a mating connector.

The bottom of base portion 132 may include columns of pockets 134. The mounting ends of the terminals 110 may extend into pockets 134. Solder balls 140 may be fused to mounting ends of the terminals within pockets 134. When terminal subassembly 110 is incorporated into a connector with other like terminal subassemblies, the solder balls of each terminal subassembly form one or more columns of solder balls and, in the aggregate, the solder balls of the terminal subassemblies form a ball grid array (BGA) at the mounting interface of the connector. According to some embodiments, the solder balls 140 have a diameter between 20 and 25 mils.

Terminal subassembly 100 may also include a conductor, which may be connected to one or more ground conductors of a PCB to which the connector is mounted. The grounded conductor may be planar, and may act as a shield, such as shield 120.

The grounded conductor may extend parallel to and adjacent at least one column of terminals. That grounded conductor may extend sufficiently toward or past the bottom of the connector housing such that a portion of the grounded conductor will be between at least a portion of the solder balls fused to the tails in adjacent columns. Shield 120 is an example of such a grounded conductor. Here, shield 120 is between columns 112 and 114 of terminals. A bottom edge of shield 120 is here shown extending beyond the bottom of housing 130. In this position, shield 120 may prevent crosstalk, particularly at the mounting interface of the connector and provide for a uniform impedance along signal paths through terminals 110. As shown, shield 120 is a flat plate substantially in the middle of the columns 112 and 114 of signal terminals and extends past by the bottom surface of the housing 130 such that at least 80% of the volume of the solder balls is adjacent to the shield (i.e. less than 20% of the volume of the solder balls extends beyond the bottom edge of the shield). In other examples, the shield may extend by different amounts, such as to be adjacent to at least 25% of the volume of the solder balls or at least 50% of the volume of the solder balls.

In this example, shield 120 is within housing 130. Housing 130 may include a slot into which shield 120 is inserted. Alternatively, housing 130 may be molded over shield 120. In the example of FIGS. 3A, 3B, 3C, and 3D, housing 130 is molded over shield 120, leaving a top edge 124 exposed at the top of wall portion 136 and a bottom edge 122 at the bottom of base 132.

Top edge 124 may be configured to contact a ground structure in a mating connector. In some embodiments, shield 120 may be connected to ground near its top and bottom edges. Shield 120 may include projections adjacent edge 122 at the mounting interface. The projections may provide a mechanism for connecting shield 120 to ground conductors on the PCB to which a connector containing terminal subassembly 100 is mounted. In this example, the projections are configured as one or more pins 150. The pins may be configured to be inserted into corresponding holes of a PCB for pin-in-paste termination.

Pin-in-paste termination may be achieved by a reflow soldering process using automated machinery. According to this process, a connector may be loosely held on a PCB, with the pins extending from the connector extending into holes of the PCB with solder paste around the holes. When the PCB is placed in a reflow oven, the paste becomes liquified solder. Due to capillary action, the solder is sucked into the hole, forming a permanent bond between the pin and conductive structures of the PCB inside the hole.

Referring back to FIG. 2A, when the connector is electrically connected to the PCB through the BGA termination and pin-in-paste, the shield may be offset from the PCB in the areas where the pins are not inserted in the PCB, so as to form a small gap 160 between the shield and PCB.

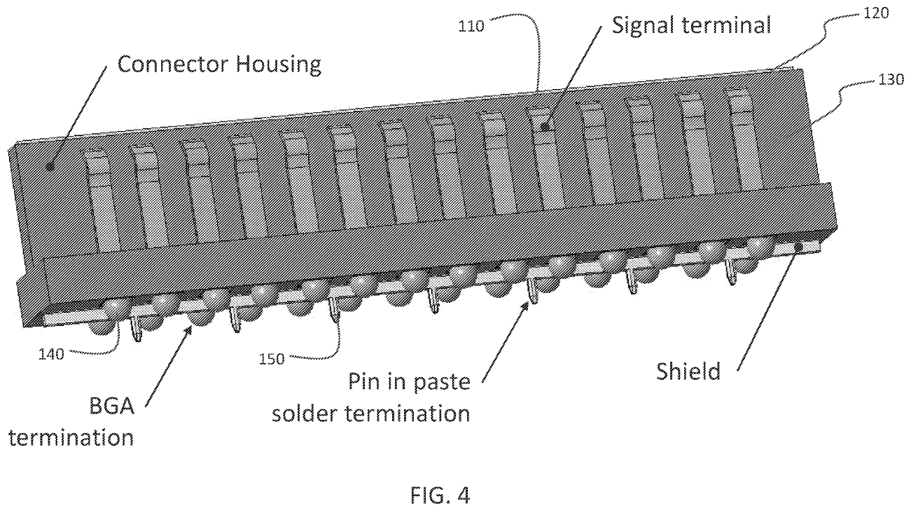

FIG. 4 is a perspective view of terminal subassembly 100, according to some embodiments.

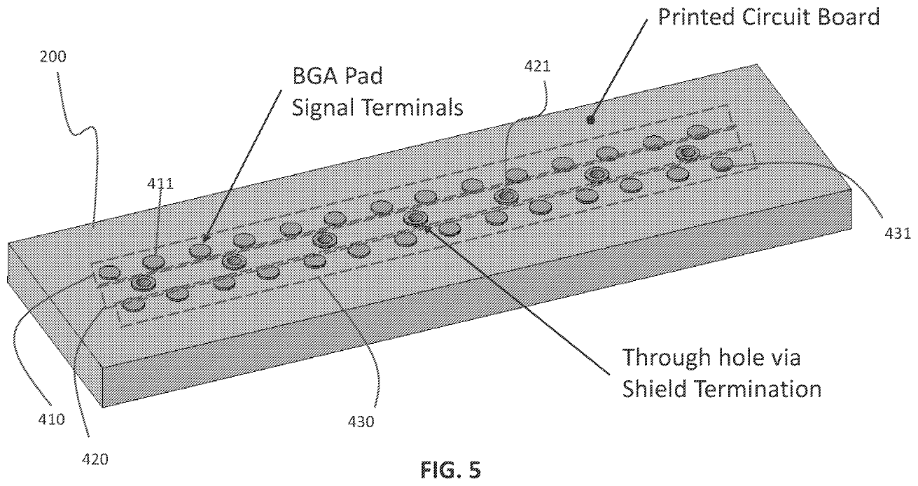

FIG. 5 is a perspective view of the PCB of FIGS. 2A-B, according to some embodiments. PCB 200 may comprise one or more contact pads configured to be electrically connected to signal terminals of a connector, such as signal terminals 110 of terminal subassembly 100 described herein. The conductive pads may be electrically connected to traces or other conductive structures within the printed circuit board 200. The contact pads may be ball gate array (BGA) pad signal terminals.

The contact pads may include a first and second plurality of contact pads. The first and second plurality of contact pads may be configured to be electrically connected to first and second signal terminals of the connector using, for example, ball gate array (BGA) termination. The first and second plurality may be arranged in columns such as columns 410 and 430. The column 410 comprises one or more contact pads 411. The column 430 comprises one or more contact pads 431.

The PCB may also include a plurality of holes 421 configured to be electrically connected to a shield of a connector, such as shield 120 of terminal subassembly 100. The holes may be through holes. Interior surface s of the holes may have a conductive plating that makes contact to ground planes within the PCB. The plurality of holes may be configured to receive for example, a plurality of pins of the shield of the connector. The plurality of holes may be arranged in a column 420, and the column 420 may be disposed between the columns of signal terminals 410 and 430. According to some examples, the holes may have a drill size of between 9 mils and 13 mils (e.g., 11 mils). Drill size can be the diameter of the hole without the conductive plating.

According to some embodiments, a connector may have pairs of terminals in each column spaced along the column at a center-to-center pair pitch of between 4 and 5 mm. In some examples, the connector may have a density greater than 9 Differential Pairs (DP)/cm². In some examples, the connector may have a density between 9 and 12 DP/cm².

In some embodiments, a size of the holes for the pins may be larger than the pins by a chosen ratio. For example, the size of the holes may be chosen so that during reflow, the connector can self-center, such that the surface tension of the solder balls between the tails of the connector and the pads on the PCB will pull the connector into a position in which the tails are aligned with the pads. The holes, for example, may have a diameter that is sufficiently larger than the pin inserted in the hole that the pin may move within the hole by at least a distance equaling 10% of the diameter of the hole.

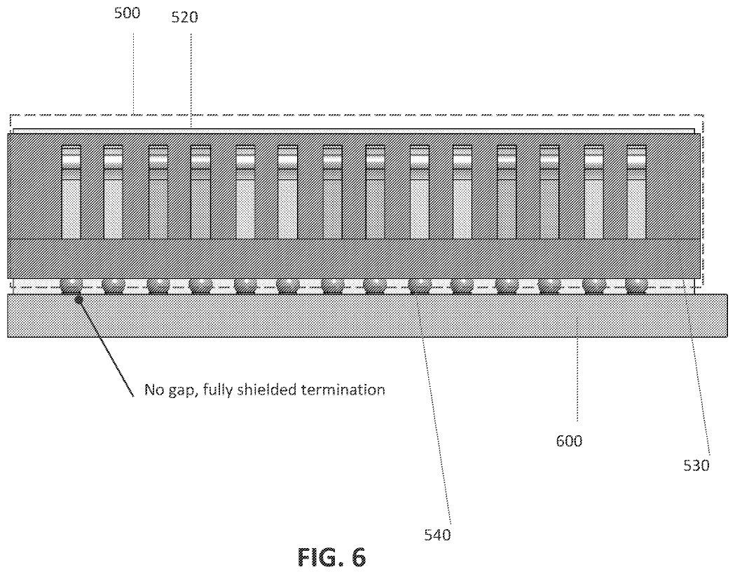

FIG. 6 is an alternative interconnection system, according to some embodiments.

In a non-limiting embodiment, the connector may include signal terminals configured to be electrically connected to a printed circuit board in which the connector is configured to be mounted to a surface of the printed circuit board. The connector may include a shield with an edge configured to be below the surface of the printed circuit board, wherein the shield is configured for electrical connection to a ground structure of the printed circuit board.

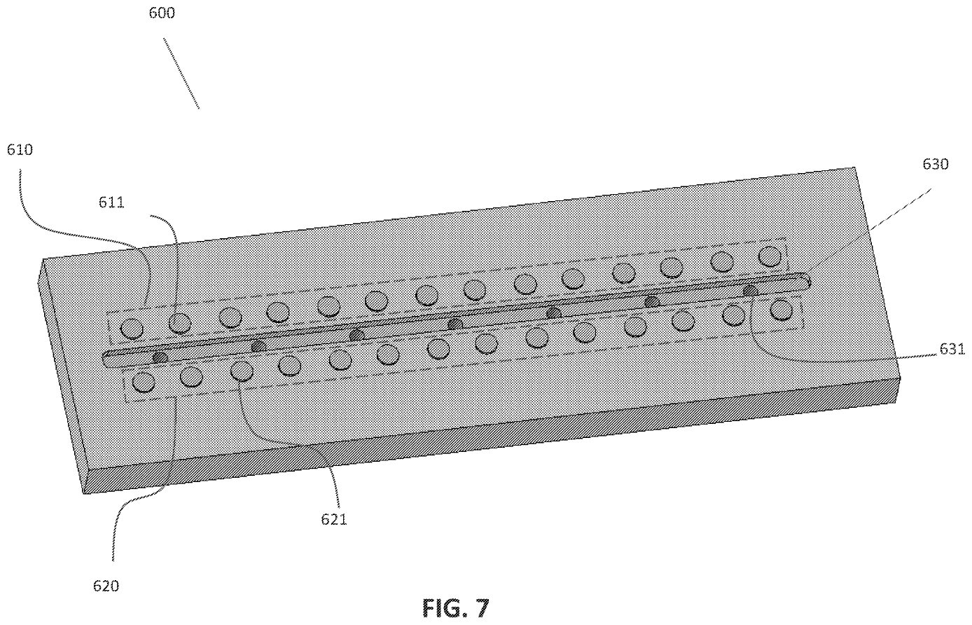

FIG. 7 is a perspective view of a PCB of the alternative interconnection system of FIG. 6, according to some embodiments. In FIG. 7, the PCB 600 includes a milled slot 630. The milled slot 630 may expose a ground layer of a PCB. The milled slot may also include one or more through holes 631. Pins, e.g., for pin-in-paste attachment to the PCB, of a shield of a connector, such as terminal subassembly 500, may be configured to be inserted into the through holes 630. The pins may be electrically connected to the ground layer of the PCB when the pin-in-paste soldering process is completed. As described herein, by mixing termination types, the shields that prevent crosstalk can get closer down to the board and closer to the ground of the PCB in order to provide better shielding to the electrical contacts.

For example, the solder balls 540 of terminal assembly 500 may extend beyond the bottom of the housing 530 of terminal assembly 500 by a first distance and the grounded conductor 520 may extend beyond the bottom of housing 530 by a second distance, greater than the first distance. An edge of each grounded conductor 520 may extend into a slot on a surface of the PCB when the assembly is mounted to a surface of the PCB, for example, with a reflow operation described herein.

PCB 600 may comprise one or more contact pads configured to be electrically connected to signal terminals of a connector. The contact pads may include a first and second plurality of contact pads arranged in columns, such as columns 610 and 630. The column 610 comprises one or more contact pads 611. The column 620 comprises one or more contact pads 621. Each pad may be sized for a solder ball connection to a respective signal terminal with a small solder ball for high frequency performance. Each solder ball, for example, may have a diameter of less than 30 mils, such as a diameter between 20 and 25 mils.

In the embodiment of FIGS. 6 and 7, because the milled slot 530 provides for a connection of the pins of the shield of the connector to be at a lower plane than that of the BGA, there is no gap 160 in this embodiment between the shield and the surface of the PCB containing the pads to which solder balls are attached.

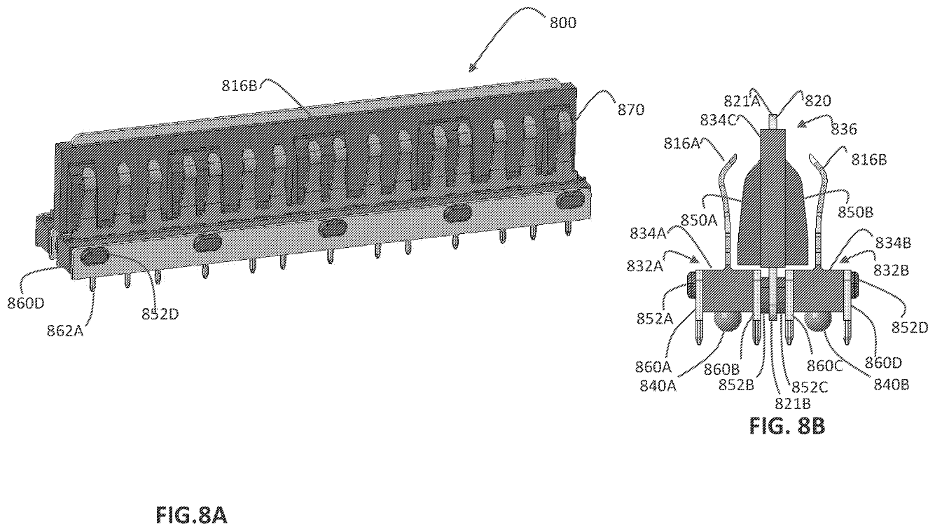

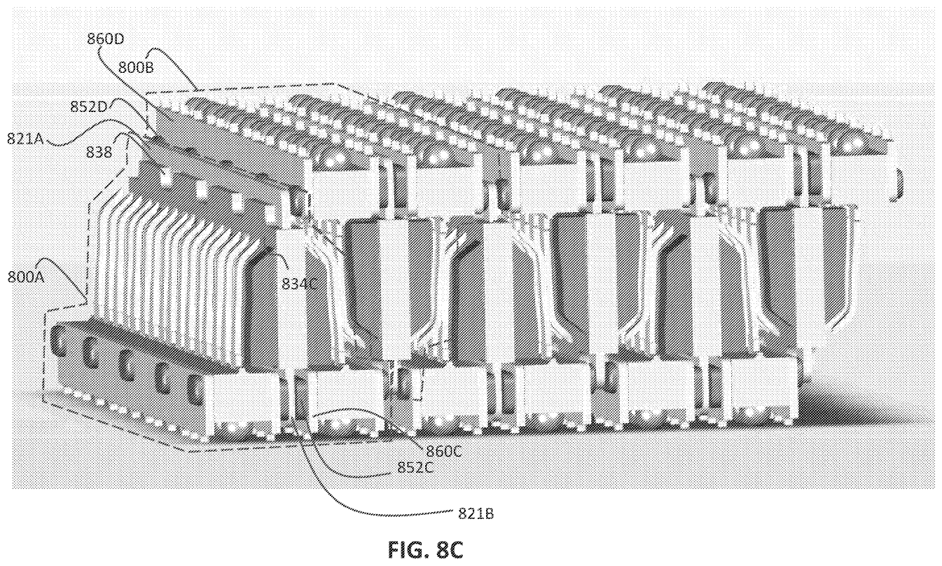

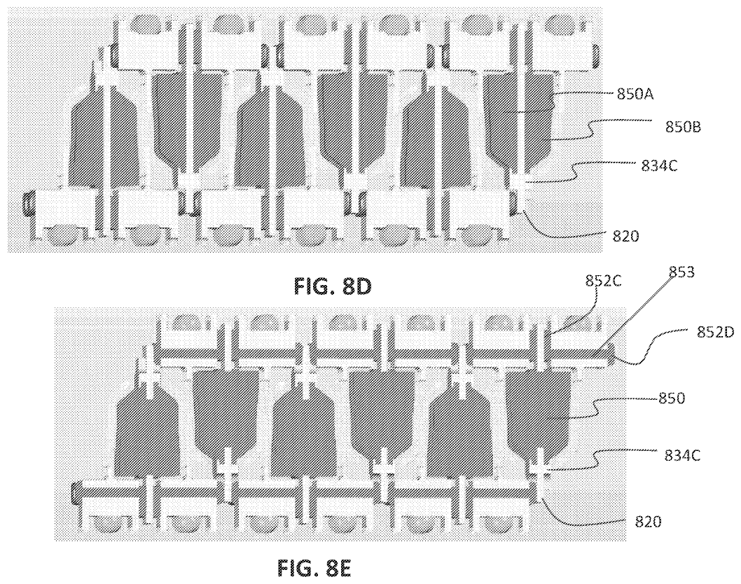

FIGS. 8A and 8B are a side perspective view and an end view of a terminal subassembly configured for mounting to a PCB using a hybrid termination technique, according to some embodiments. In this example, the terminal subassembly 800 has two columns of terminals 816A and 816B. The two columns of terminals may be arranged parallel and/or adjacent to one another. Base sub portions 832A and 832B include terminals 816A and 816B, respectively.

The base sub portions 832A and 832B may include corresponding housing sub portions 834A and 834B, respectively. Intermediate portions of the terminals 816A and 816B are held in housing sub portions 834A and 834B. The housing sub portions may be molded over the intermediate portions of the terminals, or the terminals may be inserted into openings in the housing sub portions.

Each base sub portion may also include one or multiple conductors, which may be connected to one or more ground conductors of a PCB to which the terminal subassembly 800 is mounted. In the example of FIGS. 8A and 8B, the conductor may be a planar conductor and may operate as a shield. For example, shields 860A and 860B extend on either side of housing sub portion 834A and shields 860C and 860D extend on either side of housing sub portion 834B. As described above in connection with FIGS. 2A and 7, shields 860A and 860B may each have an edge that extends beyond the housing sub portion to provide shielding between solder balls mounting signal terminals to a PCB. The shields 860A and 860B may extend from housing sub portion 834A and 834B a sufficient distance to be adjacent to at least 25% of the volume of the solder balls of the terminal subassembly, such as more than 50% or 80% of the volume of the solder, in some examples. As a specific example, the shields may extend from the housing sub portion further than the solder balls so that there is no gap between shields 860A and 860B and the surface of the PCB to which the terminal subassemblies are mounted. As in FIG. 7, an edge of shields 860A and 860B may extend into a slot on the PCB.

Each housing sub portion 834A and 834B may include columns of pockets (not shown here), which may be sized and shaped as described above. Mounting ends of corresponding terminals 816A and 816B may extend into the pockets. As described in relation with FIGS. 3A, 3B, 3C and 3D solder balls 840A and 840B may be fused to mounting ends of the corresponding terminals 816A and 816B within the pockets.

The two base sub portions 832A and 832B as well as the corresponding terminals 816A and 816B may be arranged on either side of a wall portion 836. The wall portion 836 may include a conductor, which may be connected to one or more ground conductors of a PCB to which the connector is mounted, as will be described in further detail in relation with FIG. 8D and FIG. 8E. The conductor may be planar, and may act as a shield, such as shield 820. Shield 820 may prevent crosstalk between the terminals 816A and 816B in a similar manner as described in relation with shield 120.

In this example, shield 820 is within housing portion 834C. In the example of FIGS. 8A, 8B, 8C, and 8D, housing 834C is molded over shield 820, leaving a top edge 821A exposed at the top of wall portion 836 and a bottom edge 821B at the bottom of housing 834C.

In the illustrated embodiment, two types of material are molded over shield 820. A first portion of the molded over material may be insulative and may be formed of a material conventionally used to form insulative housings of connectors. A second portion of the molded over material may be lossy. In the example of FIG. 8A . . . 8E, each terminal subassembly may include one or more columns of terminals in which some terminals are designated as signal terminals and others are designated as ground terminals. The signal terminals may be arranged in pairs and one or more ground terminals within the column may be on each side of a pair of signal terminals. The lossy portions may be preferentially positioned adjacent the ground terminals.

In certain portions, a lossy projection may extend from the housing 834C and/or may pass through an opening in shield 820, as will be described further in relation with FIG. 8D and FIG. 8E. In this example, the lossy projections may extend from the housing and shield in two opposing directions such that the housing and shield are provided substantially in the middle of lossy projection. As illustrated, for example, the lossy projections 850A and 850B extend on two sides of the housing and shield. Though not visible in FIG. 8, shield 820 may include openings aligned with projections 850A and 850B such that projections on two sides of shield 820 may be easily molded in one operation.

The bottom edge 821B of shield 820 may extend between base sub portions 832A and 832B. Shield 820 may be electrically and mechanically coupled to base sub portions 832A and 832B. In the illustrated example, lossy material may pass through both base sub portions 832A and 832B and shield 820, mechanically coupling those portions of the terminal subassembly. Lossy material may be introduced, such as through molding, to fill channels in base sub portions 832A and 832B and flow through openings in shield 820.

The lossy material may electrically connect shield 820 and ground structures within base sub portions 832A and 832B. In this example, the lossy material may be formed as plastic filled with conductive particulate such that it may be readily molded and may provide a conductivity sufficiently high to form electrical connections, such as a bulk conductivity above 50 Siemens/meter or above 200 Siemens/meter, in some embodiments, or between 50 Siemens/meter and 30,000 Siemens/meter in some examples. Lossy portions 852B and 852C, for example, may be exposed portions of the lossy material. These lossy portions extend between and are electrically coupled to shields 860B and 860C of base sub portions 832A and 832B, respectively.

The lossy portions 852B and 852C may intersect the base sub portions 832A and 832 respectively in one or multiple portions of the terminal subassembly. For example, the lossy portions 852B and 852C may protrude on either side of the terminal subassembly 800 as lossy portions 852A and 852D respectively. This is described further in relation with FIGS. 8D and 8E. According to some embodiments, the lossy portions 852A and 852D may be contact pads for mating with a conductive ground structure in a complementary connector, as shown in FIGS. 8C to 8E.

FIG. 8C is an end perspective view of a plurality of terminal subassemblies formed using construction techniques described in connection with FIGS. 8A and 8B, held together as a first connector, mated to a second connector comprising a plurality of like terminal subassemblies. Support members holding the terminal subassemblies together are not expressly illustrated, but support structures as described above may be used. The portions of the pins received in such vias are not shown in FIG. 8C . . . 8E, as those figures show the portions of connectors extending about the surface of a PCB when the connector is mounted to the PCB.

In the example of FIG. 8C, housing 834C of terminal subassembly 800A has cut-outs 838 on either side of the exposed portion of shield 820. The cut-outs may correspond to lossy portions 852A (not shown here) and 852D, such that when the first connector is mated to the second connector in the manner of FIG. 8C, the lossy portions 852A and 852D of a first connector may be inserted into the cut-outs 838 of the second, mating, connector where they will electrically couple to shield 820.

The top edge 821A of a first terminal subassembly 800A may be configured to contact the lossy portions 852D of an adjacent terminal subassembly 800B from the second connector. The lossy portions 852D may provide electrical connectivity to ground through shield 860D when the terminal subassembly 800B is mounted to a PCB and shield 860D is grounded.

Similarly, the bottom edge 821B of the shield 820 of the first terminal subassembly may be configured to contact lossy portions 852B and 852C. The lossy portions 852B and 852C may provide electrical connectivity to ground through shields 860B and 860C, respectively.

FIG. 8D is a cross section through the mated first connector and second connector of FIG. 8C at a first location. As described herein, in the first location, the lossy projection 850 may intersect the shield 820 such that shield 820 is substantially in the middle of lossy projection 850. Accordingly, the cross section of FIG. 8D illustrates portions of shield 820 that are substantially solid, and these portions may be preferentially positioned to be adjacent signal terminals.

FIG. 8E is a cross section through the mated first connector and second connector of FIG. 8C at a second location, passing through projections 850A and 850B, which are adjacent ground terminals of the terminal subassemblies. As described herein, at the second location, the lossy projection 850 may intersect both the shield 820 and housing 834C such that shield 820 and housing 834C are substantially in the middle of lossy projection 850.

As described herein, the lossy portions such as 852B and 852C may pass through the base sub portions 832A and 832 at the second location. In this example, the lossy portion 852C has an intermediate portion 853 passing through the housing sub portion 834B and shields 860C and 860D. Lossy portion 853 may also pass through corresponding housing sub portion 834A and shields 860A and 860B. In this way, electrical connections may be established between shield 820 and shields 860A and 860B. The ground structures within the terminal subassembly may be interconnected and may support ground current flow through the terminal subassembly, from a top edge 821A, which mates to a complementary connector, to pins 862A on the shields 860A, B, C, D, which are connected to ground structures on a PCB. Optionally, the lossy portions may also pass through or around ground terminals within the terminal subassembly to provide further interconnection of grounding structures within the terminal subassembly and a further current flow path for ground current.

FIG. 8E shows one location within the terminal subassembly in which lossy material interconnects shield 820 and planar conductive members 860A, B, C, D of a terminal subassembly and provides contact locations for mating to terminal subassemblies of a mating connector. FIGS. 8A and 8C illustrate that there may be multiple such locations along the length of a terminal subassembly. In the illustrated example, each terminal subassembly includes five such locations, corresponding to four pairs of signal terminals in a column, with five groups of ground terminals along the column, one on each side of each of the pairs of signal terminals. In this example, the pairs of the signal terminals in each column are aligned, as are the ground terminals. Further, in this example, the groups of ground terminals between pairs contain two ground terminals, with the groups of ground terminals at each end of the column containing only one ground terminal.

The lossy portions and lossy projections described herein may be made of an electrically lossy material, as described in further detail herein.

In the state illustrated in FIG. 8A, terminals 816B of terminal subassembly 800 are shown joined by a tie bar 870. One or more tie bars may be present at intermediate stages in the manufacture of terminal subassembly 800, but the tie bar 870 may be cut away, electrically separating the terminals, before manufacture of the terminal subassembly is complete. Accordingly, tie bar 870 may be absent from a finished connector.

A terminal subassembly may be formed, for example, by stamping a column of terminals from a sheet of metal. The terminals may, when initially stamped, be joined by one or more strips of metal from that sheet. The strips of metal may hold the terminals in position with respect to each other. The terminals may then be over molded with insulative material forming a housing portion for the terminal subassembly. Because the spacing of the terminals is controlled by the stamping die, the positions of the terminals with respect to each other may be controlled even during an over molding operation. Once the over molding operation is completed, the over molded housing portion may hold the terminals in position and the tie bar may be cut away. In this example, tie bar 870 may be cut away after housing sub-portion 834B is molded around terminals 816B and before lossy portions 852A, 852B, 852C and 852D are molded.

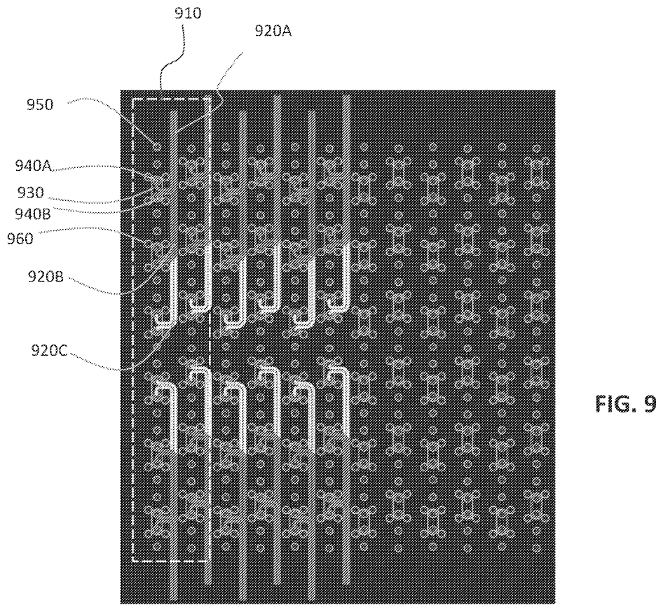

FIG. 9 is a sketch of a portion of a connector footprint on a PCB to which a connector using a hybrid termination technique is attached, according to some embodiments.

Section 910 is a portion of the connector footprint to which may be mounted a single terminal subassembly. In the example, signal and ground terminals within a terminal subassembly are attached to the PCB using BGA attachment. Planar ground conductors may be connected using pin and paste attachment. In this example, the terminal subassembly may include housing sub portions, as in the example of FIG. 8A, 8B, 8C and 8D. However, the arrangement of the terminals aligning with the illustrated footprint differs from the terminal arrangement illustrated in the terminal subassembly of FIGS. 8A, 8B, 8C and 8D.

Section 910 may be repeated for each of the terminal subassemblies in a connector, resulting in a connector footprint as illustrated in FIG. 9 with multiple parallel columns of mounting locations for terminals. In this example, each of the terminal subassemblies has two columns of terminals arranged as six pairs of signal terminals and seven groups of ground terminals. Further, in this example the centers of the pairs in a first column are offset, in the column direction, from the centers of the pairs in a second, adjacent, column. Additionally, the group of ground terminals at one end of each column includes two ground terminals, while the group at the other end has only one ground terminal. Such a terminal subassembly may be constructed from two base sub portions of the same configuration, but one base sub portion may be rotated 180 degrees with respect to the other.

Sets of traces 920A, 920B, and 920C may represent traces within the same routing channel on different layers of a PCB. For example, set of traces 920C may be provided on a lower layer than set of traces 920B, which is provided on a lower layer than set of traces 920A. Each of the traces connects to a signal hole. In the example of FIG. 9, the trace sets include two traces for a differential pair 930.

The section 910 may include one or multiple anti-pads 950. The anti-pads 950 represent void areas in the internal ground layers of the PCB around the vias 940A and 940B, such that the vias 940A and 940B are not connected to ground. The vias 940A and 940B within an anti-pad 950 may be connected to a set of traces, such as 920A, 920B, or 920C. When terminal subassembly is mounted to a PCB with a section 910 of a connector footprint, solder balls fused to signal terminals are electrically connected to vias such as vias 940A and 940B. The PCB may be manufactured with a pad on a surface above each of the vias 940A and 940B, for example, and a solder ball may be fused to that pad.

The vias 950 provided outside of the anti-pads, in line with the vias in the anti-pads may be connected to ground structures within the PCB. These vias may similarly intersect pads on the surface of the PCB for solder ball attachment of ground terminals in the terminal subassembly.

The vias 960 on either side of the anti-pads 950 may also be connected to ground structures within the PCB. These vias may be configured to receive pins, such as pins 862A, of planar conductors of the base sub portions, such as shields 860A-D. One or more shadow vias may optionally be included. Shadow vias may be small drill plated-through holes (PTH) vias that may be used in the vicinity of a differential pin pair, e.g., such as pin pairs to be mounted to 940A and 940B, to provide desirable common and differential transmission. The shadow vias may be allowed to plate shut. For example, the vias may be filled in with conductive material making electrical connection to a ground layer of the PCB. According to some embodiments, the diameter of the shadow vias may be smaller than the diameter of the vias 960 that receive the pins. The vias 960 may also have a larger diameter than the ground vias 950 and/or signal vias 940A and 940B.

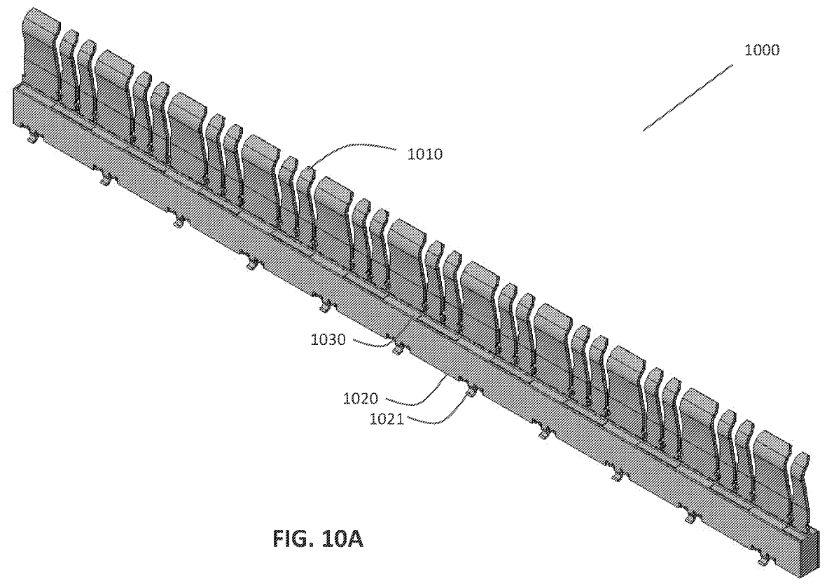

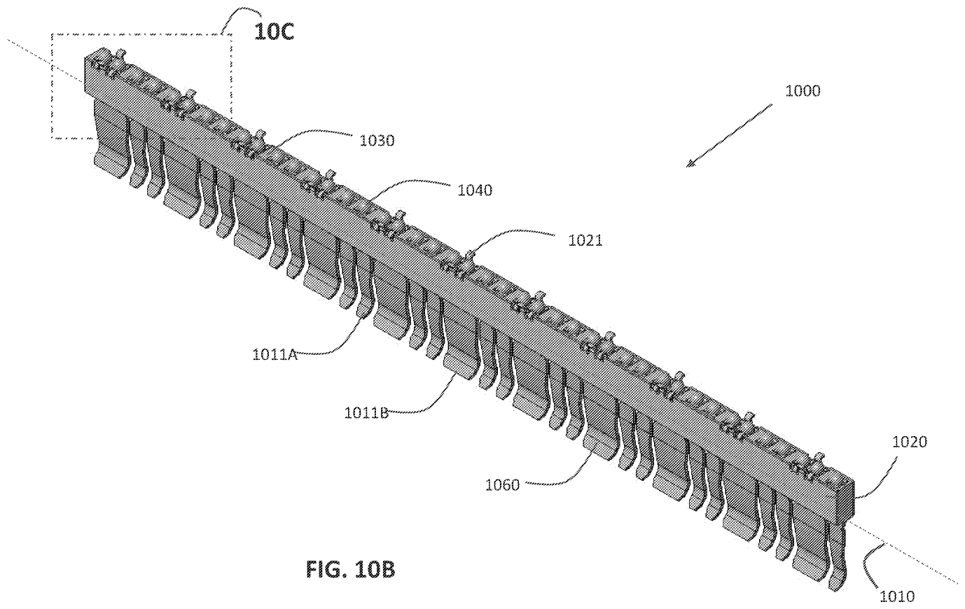

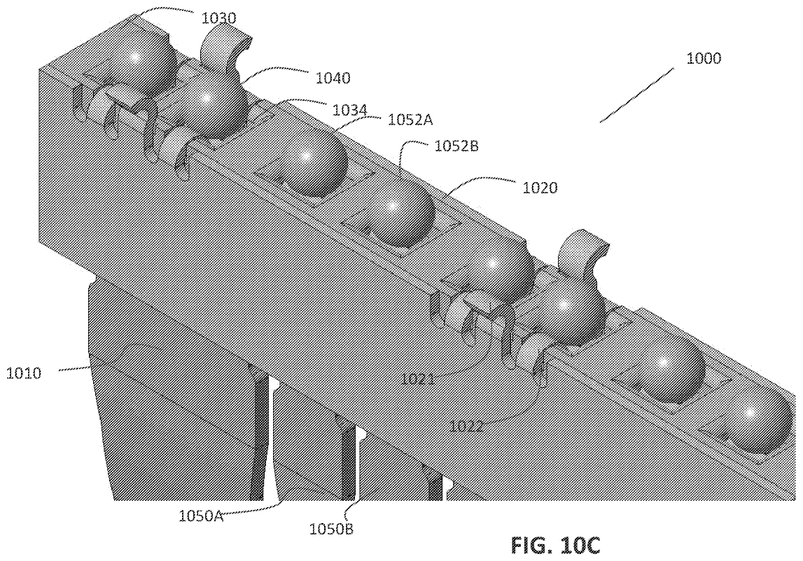

FIGS. 10A and 10B are a top, side perspective view and a bottom, side perspective view, respectively, of a terminal subassembly 1000 configured for mounting to a PCB using an alternative hybrid termination technique, according to some embodiments. FIG. 10C is an enlarged view of the portion of the terminal subassembly labeled 10C in FIG. 10B.

FIG. 10C illustrates that the column of terminals within the terminal subassembly includes pairs of signal terminals 1050A and 1050B. One or more ground terminals 1060 may be positioned on each side of the pair of signal terminals 1050A and 1050B. In this example, tails of both signal and ground terminals terminate in pockets on a bottom of the terminal subassembly housing, where solder balls 1052A, 1052B and 1040 are respectively fused to the tails. In this example, each ground terminal 1060 is wider than a signal terminal and two solder balls 1040 are fused to each ground terminal 1060.

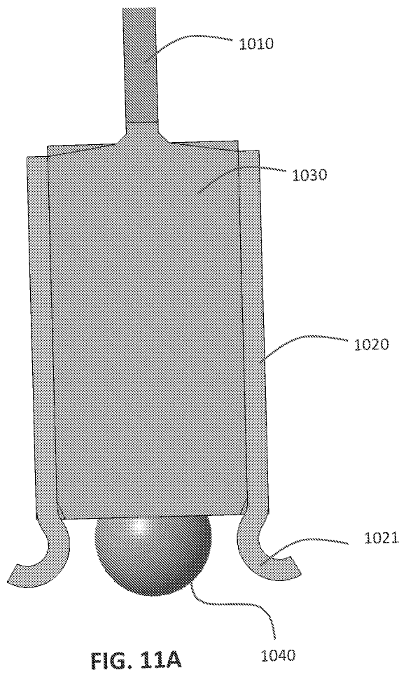

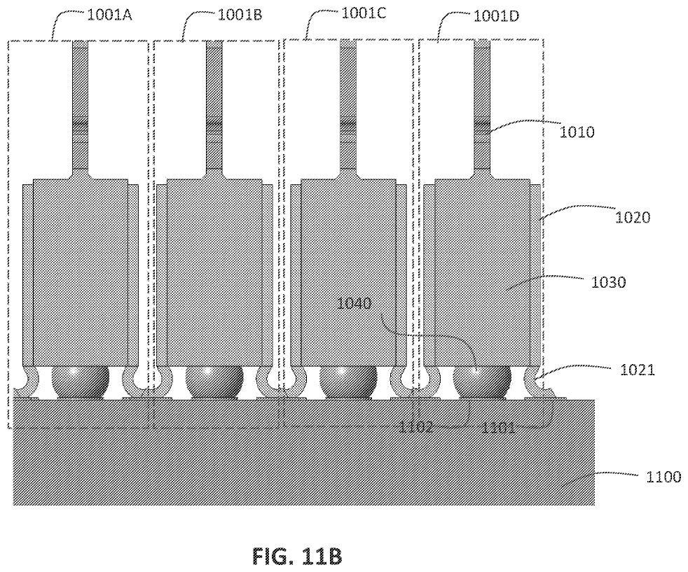

As shown in FIG. 11B, multiple terminal subassemblies 1000 may be held together to form a connector with multiple parallel columns of terminals. The terminal subassembly 1000 may be connected to PCB 1100 using hybrid techniques. For example, one or more shields of terminal subassembly 1000 may have leads, such as J-leads or gull wing leads, configured to be mounted to pads of a PCB using surface mount technology.

The terminal subassembly 1000 may include a housing 1030. As described herein, housing 1030 may be made of an insulative material, such as nylon or other thermoplastic. Housing 1030 may hold a column 1010 of terminals. The terminals may include signal terminals 1011A and ground terminals 1011B. Housing 1030 may hold terminals 110. For example, the housing 1030 may be molded over intermediate portions of terminals 1010. Alternatively, the terminals may be inserted into openings of the housing.

When a connector including a terminal subassembly 1000 is mounted to a PCB, ground terminals 1011B may be electrically connected to one or more ground conductors of the PCB. According to some embodiments, the signal terminals may be of a first width and the ground terminals may be of a second width, wherein the second width is greater than the second width, e.g., substantially double.

The bottom of housing 1030 may include a column of pockets 1034. The mounting ends of the terminals 1010 may extend into pockets 1034 and the solder balls 1040 may be fused to the mounting ends of the terminals within the pockets. As described in relation to the terminal assembly 1000, when terminal subassembly 1000 is incorporated into a connector with other like terminal subassemblies, the solder balls 1040 of each terminal subassembly may form multiple columns of solder balls that form a ball grid array (BGA) at the mounting interface of the connector.

Terminal subassembly 1000 may also include one or multiple conductors, which may be connected to one or more ground conductors of a PCB to which the connector is mounted. The grounded conductors may be planar and may act as a shield. For example, terminal subassembly 1000 includes two grounded conductors extending parallel to and adjacent to the column 1010 on opposite sides of the housing 1030 and act as a shield 1020. When the terminal subassembly 1000 is incorporated into a connector with other like terminal subassemblies as described herein, the shield 1020 may prevent crosstalk between column 1010 of terminals and other columns corresponding to other terminal subassemblies.

As described herein, the mounting ends of the electrical contacts 1010 may have edges that are solder-wettable with surfaces joining the edges having a non-solder wettable coating. The mounting ends of both contacts 1011A and 1011B can include projections that extend into pockets formed in a surface of the housing. The shield 1020 may include projections such as J-leads or gull wing leads 1021. In this example, the projections are configured as one or more gull wing leads 1021, and the gull wing leads connect the shield 1020 to ground conductors of a PCB. The leads may be configured to be mounted to corresponding pads of a PCB using a surface mount termination technique.

The shield 1020 may also include projections 1022. The projections 1022 may be shaped to provide electrical contact with solder balls 1040 when the electrical contacts of terminal subassembly 1000 receive solder balls 1040 at their mounting ends. For example, the projections 1022 of the shield may be curved inwards towards the centerline of a column of terminals in the terminal subassembly. The curved ends of the projections 1022 may extend into pockets 1034 in a surface of the housing 1030 configured for mounting against the circuit assembly. The ends of the projections 1022 may be each fused to a respective tail of the terminals 1010 via a portion of a solder ball disposed within a corresponding pocket 1034.

FIG. 11A is an end view of the terminal subassembly in FIG. 10A.

FIG. 11B is an end view of multiple terminal subassemblies as in FIG. 10A mounted to a printed circuit board. The structure 1000 of FIGS. 10A, 10B, and 10C may be repeated to form a connector with multiple parallel columns of terminals. For example, terminal subassemblies 1001A, 1001B, 1001C, and 1001D are mounted to the PCB 1100 in adjacent parallel columns. The projections 1021 are mounted to the pads 1101. The solder balls 1040 are mounted to pads 1102.

In some examples, a connector as described herein may include one or multiple terminal subassemblies 1000 as shown in FIGS. 10A, 10B and 10C. For example, as in FIG. 11B, the connector may have 4 terminal subassemblies. In alternative examples, the electronic assembly may include more than one such connector. For example, the assembly may include a second printed circuit board, parallel to the first printed circuit board and a second connector mounted to the second PCB, mated to the first connector. In some embodiments, the first printed circuit board and the second printed circuit board are separated by a distance between 3 millimeters (mm) and 6 mm (e.g., 4 mm, 5 mm).

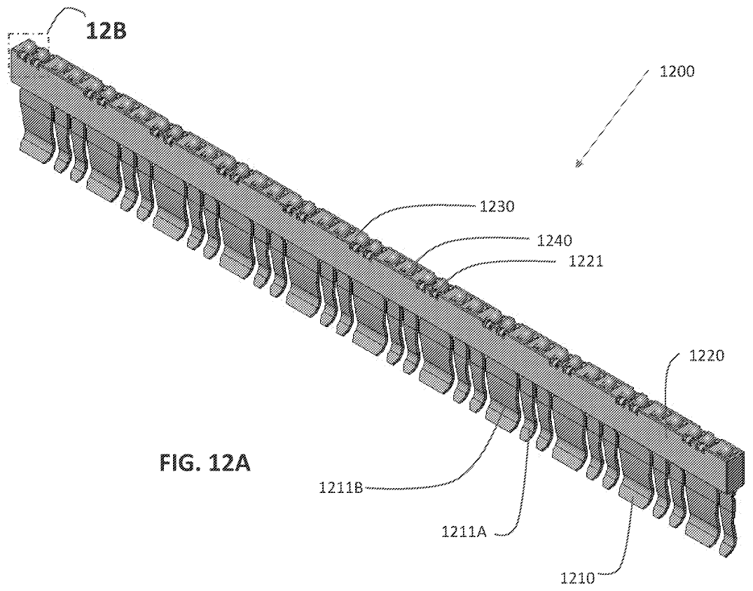

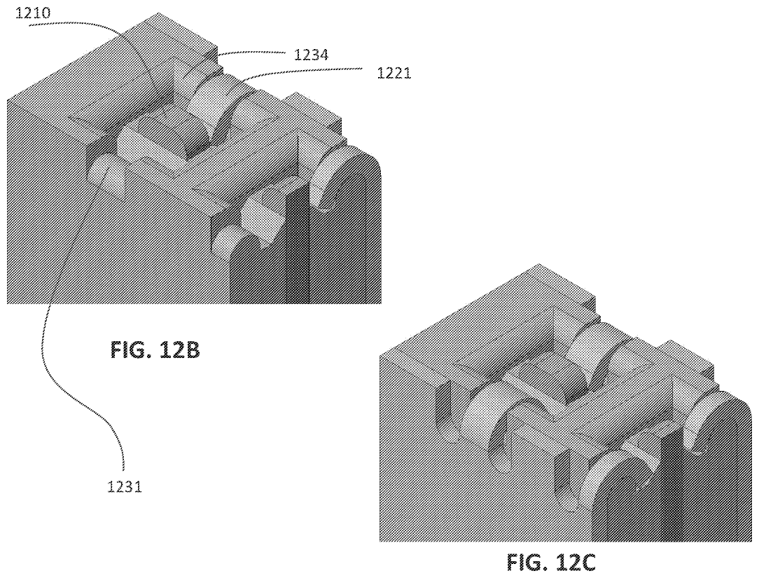

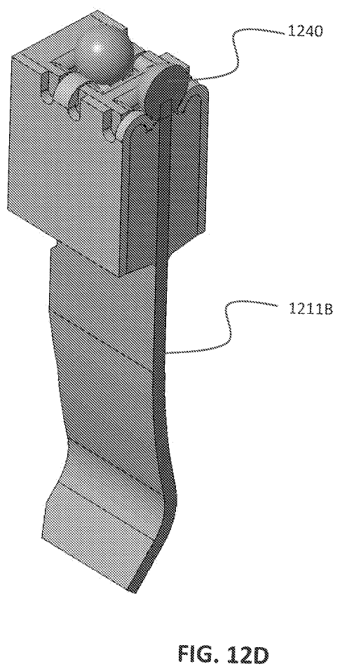

FIG. 12A is a bottom, side perspective view of an alternative embodiment of a terminal subassembly configured for mounting to a PCB, according to some embodiments. In this example, the terminal subassembly includes planar ground conductors that may provide shielding and/or impedance control at the mounting interface of a connector containing subassemblies as illustrated in FIG. 12A. Yet, no additional mounting locations are required to connect the planar grounded conductors to ground structures within a PCB to which the connector is mounted. Rather, a connection to a ground of the PCB is made through the solder balls used to connect ground terminals to ground of the PCB. The terminal subassembly of FIG. 12A may be as described above in connection with terminal subassembly 1000, with gull wing leads 1021 omitted.

FIG. 12B is an enlarged view of the portion of the terminal subassembly labeled 12B in FIG. 12A in a manufacturing state in which a first planar conductor is attached and before solder balls are fused to the tails of ground conductors of the terminal subassembly.

FIG. 12C is an enlarged view of the portion of the terminal subassembly labeled 12B in FIG. 12A in a manufacturing state in which a first and second planar conductors are attached and before solder balls are fused to the tails of the terminals in the terminal subassembly.

As in FIGS. 11A, 11B, 11C, and 11D, the structure 1200 may be repeated to form a connector with multiple parallel columns of terminals. The terminal subassembly 1200 may include a housing 1230 made of an insulative material, such as nylon or other thermoplastic.

Housing 1230 may hold a column 1210 of terminals, of which may include signal terminals 1211A and ground terminals 1211B. As described herein, housing 1230 may hold terminals 1210. For example, the housing 1230 may be molded over intermediate portions of terminals 1210 or inserted into openings of the housing. The ground terminals 1211B may be electrically connected to one or more ground conductors of a PCB. According to some embodiments, the signal terminals may be of a first width and the ground terminals may be of a second width, wherein the second width is greater than the second width, e.g., substantially double.

The bottom of housing 1230 may include a column of pockets 1234. The mounting ends of the terminals 1210 may extend into pockets 1234 and the solder balls 1240 may be fused to the mounting ends of the terminals within the pockets.

Similar to the structure described with relation to terminal assembly 1000, terminal subassembly 1200 may also include one or multiple conductors, which may be connected to one or more ground structures of a PCB to which the connector is mounted. The grounded conductors may be planar and may act as a shield. For example, terminal subassembly 1200 includes two grounded conductors extending parallel to and adjacent to the column 1210 on opposite sides of the housing 1230 and act as a shield 1220. When the terminal subassembly 1200 is incorporated into a connector with other like terminal subassemblies as described herein, the shields 1220 may prevent crosstalk between column 1010 of terminals and other columns in other terminal subassemblies.

As described herein, the mounting ends of the electrical contacts 1210 may have edges that are solder-wettable, and surfaces joining the edges may have a non-solder wettable coating. The mounting ends of the contacts may include projections that extend into pockets formed in a surface of the housing.

The shield 1220 may include projections 1221 shaped to provide electrical contact with solder balls 1240 when the electrical contacts of terminal subassembly 1200 receive solder balls 1240 at their mounting ends. In the example of FIG. 12A . . . 12D, the projections 1221 of the shield are curved such that ends of the projection extend into pockets 1234 in a surface of the housing 1230. For example, the ends of projection 1221 may be curved inwards in a direction towards the solder ball they come in contact with.

In the example of FIGS. 12B and 12C, projection 1221 wraps around indentation 1231 of shield 1230 and lines a part of a wall of the pocket 1234 such that when a solder ball is fused to the contact extending into pocket 1234, the solder ball also fuses to the projection.

FIG. 12D is an enlarged cross-section of a ground terminal, as in FIG. 12A, in a manufacturing state in which a first and second planar conductors and two solder balls are attached. The ends of the projections 1221 are fused to respective tails of a terminal, such as terminal 1211B of FIG. 12D, via a solder ball.

Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure. In other configurations, the frequency range of interest may be the operating frequency range of the connector. Unless otherwise indicated the frequency range of interest may extend from at least 1 GHz to at least 25 GHz.

Loss may result from interaction of an electric field component of the electromagnetic energy with the material, in which case the material may be termed electrically lossy. Alternatively or additionally, loss may result from interaction of a magnetic field component of the electromagnetic energy with the material, in which case the material may be termed magnetically lossy.

Generally, an electrically lossy material may be a material that conducts, but with some loss, over the frequency range of interest such that the material conducts more poorly than a conductor, but better than an insulator. Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. Such materials may contain conductive particles or regions that are sufficiently dispersed that they do not provide high conductivity or otherwise are prepared with properties that lead to a relatively weak bulk conductivity compared to a good conductor such as copper over the frequency range of interest. Electrically lossy materials of this type typically have a bulk conductivity of about 1 Siemen/meter to about 100,000 Siemens/meter and preferably about 1 Siemen/meter to about 30,000 Siemens/meter. In some embodiments, material with a bulk conductivity of between about 10 Siemens/meter and about 500 Siemens/meter may be used. As a specific example, material with a conductivity of about 50 Siemens/meter may be used. However, it should be appreciated that the conductivity of the material may be selected empirically or through electrical simulation using known simulation tools to determine a suitable conductivity that provides a suitably low cross talk with a suitably low signal path attenuation or insertion loss. It should also be appreciated that any other suitable signal integrity (SI) characteristics may be used in such empirical testing or electrical simulation for purpose of selecting conductivity of the electrically lossy material.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. However, intimate contact is not a requirement, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with signal frequencies in the range of approximately 10 GHz or higher, a reduction in the amount of electromagnetic energy in a conductor may be provided by sufficient capacitive coupling between a lossy material and the conductor with a mutual capacitance of between about 0.01 pF to about 100 pF, between about 0.01 pF to about 10 pF, or between about 0.01 pF to about 1 pF. Alternatively or additionally, the lossy material may be molded over insulative material, or vice versa, such as in a two shot molding operation, and may press against or be positioned sufficiently near that there is appreciable capacitive coupling to a ground conductor.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 40% by volume. The amount of filler may impact the conducting properties of the material.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

Also, while the above-described binder materials may be used to create an electrically lossy material by forming a binder around conducting particle fillers, aspects of the invention are not so limited. For example, conducting particles may be impregnated into a formed matrix material or may be coated onto a formed matrix material, such as by applying a conductive coating to a plastic housing. As used herein, the term “binder” encompasses a material that encapsulates the filler, is impregnated with the filler or otherwise serves as a substrate to hold the filler.

While the above-described binder materials may be used to create an electrically lossy material by forming a binder around conducting particle fillers, the disclosure is not so limited. In a non-limiting example, an electrically lossy material may comprise metal. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5.

Practical lossy magnetic materials or mixtures containing lossy magnetic materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials can be formed, for example, by using magnetically lossy fillers that are partially conductive or by using a combination of magnetically lossy and electrically lossy fillers.

Lossy portions also may be formed in a number of ways. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

The present disclosure is not limited to the details of construction, or the arrangements of components set forth in the foregoing description and/or the drawings. Various embodiments are provided solely for purposes of illustration, and the concepts described herein are capable of being practiced or carried out in other ways.

For example, the terminal subassemblies may include standoffs on the bottoms. For example, in connection with terminal subassemblies as shown in FIG. 3A . . . 3D, the housing 130 may include one or multiple standoffs (not shown) extending from the base portion 132. The standoffs may provide a gap between the bottom of the base portion 132 and a top surface of the PCB when the terminal subassembly 100 is mounted at the PCB. The standoffs may be separately attached to the housing 130 or may be molded as part of the housing 130.

As another example, the tails of terminals may be shaped in various ways to accommodate solder ball attachment. The terminals may be bent as illustrated in FIG. 1B to facilitate attachment to a surface of the tails parallel to the mounting interface of the connector. Alternatively, the tails may be shaped for the solder balls to fuse to opposing sides of the tail that are perpendicular to the mounting interface or to fuse preferentially to edges of the tails facing the mounting interface. For example, the mounting ends of the tails may have edges that are solder-wettable with surfaces joining the edges having a non-solder wettable (also known as anti-wettable) coating.

Alternatively or additionally, the mounting ends of the tails can include projections that extend into pockets formed in a surface of the housing configured for mounting against the circuit assembly. These projections may have edges that are solder-wettable, which may aid in attachment of the solder balls to the contacts. The edges may be made solder-wettable by application of solder flux, such as through the use of a flux pin transfer technique. Alternatively or additionally, the edges may be made solder-wettable by coating a solder-wettable layer to the edges, such as a layer of copper, gold, nickel, nickel-vanadium alloy.

As another example, contact pads on a surface of a PCB for BGA attachment are illustrated as circular pads. Pads may have other shapes, such as square or oval, for example.

As yet another example, one or more columns of terminals in a connector are described as implemented as a terminal subassembly. A connector may be constructed from multiple such terminal subassemblies, held together by a support. However, the same configuration of signal terminals and ground structures may alternatively be implemented with a common connector housing.

As an example embodiment, a mezzanine connector comprises: a housing having a first side and a second side, opposite the first side; a plurality of columns of terminals held within the housing, each of the plurality of terminals comprising a tail; a plurality of solder balls, each of the plurality of solder balls attached to a tail of a respective terminal of the plurality of terminals adjacent to the first side of the housing; and a plurality of conductive members, each of the plurality of conductive members extending perpendicular to the first side of the housing and parallel to and adjacent to at least one respective column of the plurality of columns of terminals, wherein each of the plurality of conductive members comprises a plurality of projections, each of the plurality of projections configured for connection to a ground structure of a printed circuit board via solder when the mezzanine connector is mounted to a surface of the printed circuit board.

Optionally, each of the plurality of conductive members comprises an edge, and the plurality of projections extend from the edge. Optionally, the edge of each of the plurality of conductive members is adjacent the first side and the plurality of projections comprise pins extending perpendicular to the first side. Optionally, the plurality of solder balls extends beyond the first side by a first distance; and each of the plurality of conductive members extends beyond the first side by a second distance, greater than the first distance. Optionally, the second distance is such that the edges of each of the plurality of conductive elements is configured to extend into a slot in a surface of the printed circuit board when the mezzanine connector is mounted to the surface of the printed circuit board with a reflow operation that fuses the plurality of solder balls to pads on the surface of the printed circuit board.

Optionally, the first side of the housing comprises a plurality of pockets; the tail of each of the plurality of terminals extends into a respective pocket of the plurality of pockets; and the plurality of projections are bent to extend into pockets of the plurality of pockets. Optionally, the plurality of solder balls are each partially disposed within a pocket of the plurality of pockets; and for each of the plurality of conductive members, the plurality of projections are each fused to a respective tail of a terminal of the plurality of terminals via a portion of a solder ball disposed within a pocket of the plurality of pockets. Optionally, for each of the plurality of conductive members, the plurality of projections are a first plurality of projections; each of the plurality of conductive members comprises a second plurality of projections; and projections of the second plurality of projections are configured as J-leads.

Optionally, the mezzanine connector comprises a plurality of terminal subassemblies, each of the plurality of terminal subassemblies comprises: a portion of the housing; and at least one column of the plurality of columns of terminals held within the housing portion. Optionally, each of the plurality of terminal subassemblies further comprises at least one conductive member of the plurality of conductive members. Optionally, each of the plurality of terminal subassemblies comprises lossy material electrically coupled to the respective at least one conductive member. Optionally, the at least one column of the plurality of columns of terminals is two columns of terminals. Optionally, for each of the plurality of terminal subassemblies: the portion of the housing comprises a first sub-portion and a second sub-portion of the housing; a first column of the at least one column of the plurality of columns of terminals is held within the first sub-portion of the housing; a second column of the at least one column of the plurality of columns of terminals is held within the second sub-portion of the housing; and for each of the plurality of terminal subassemblies, the at least one conductive member of the plurality of conductive members comprises a first conductive member attached to the first sub-portion of the housing and a second conductive member attached to the first sub-portion of the housing. Optionally, for each of the plurality of terminal subassemblies, the at least one conductive member of the plurality of conductive members further comprises a third conductive member mechanically coupled to the first sub-portion of the housing and a fourth conductive member mechanically coupled to the first sub-portion of the housing. Optionally, each of the plurality of terminal subassemblies further comprises lossy material electrically coupling the first and third conductive members and the second and fourth conductive members. Optionally, each of the plurality of terminals comprises a mating contact portion; and each of the plurality of terminal subassemblies further comprises a shield between mating contact portions of the terminals of the first column and the second column. Optionally, each of the plurality of terminal subassemblies comprises lossy material coupled to the shield, the first conductive member, the second conductive member, the third conductive member, and the fourth conductive member.

Optionally, for each of the plurality of terminal subassemblies: the portion of the housing comprises a base and a wall extending perpendicular to the base; terminals of a first column of the two columns of terminals are held in the base and comprise mating contact portions; terminals of a second column of the two columns of terminals are held in the base and comprise mating contact portions; and the wall is between mating contact portions of the terminals of the first column and the terminals of the second column. Optionally, for each of the plurality of terminal subassemblies: the at least one conductive element comprises a planar conductive element comprising a first edge extending beyond the first portion of the housing at the first side and a second edge extending from the portion of the housing at the second side. Optionally, for each of the plurality of terminal subassemblies: the portion of the housing is molded over the planar conductive element.

Optionally, for each of the plurality of terminal subassemblies: the at least one column of terminals comprises pairs of terminals of a first width and terminals of a second width, greater than the first width, interspersed with the pairs of terminals of the first width; solder balls of a first subset of the plurality of solder balls are each fused to both a respective tail of a terminal of the second width and a respective projection of a conductive member of the plurality of conductive members. Optionally, the pairs of terminals in the at least one column are spaced along the column at a center-to-center pair pitch of between 4 and 5 mm. Optionally, for each of the plurality of terminal subassemblies: for each of the plurality of conductive members, the plurality of projections are a first plurality of projections; each of the plurality of conductive members comprises a second plurality of projections; and projections of the second plurality of projections are configured as J-leads. Optionally, the mezzanine connector has a density greater than 9 Differential Pairs (DP)/cm2. Optionally, the solder balls have a diameter between 20 and 25 mils. Optionally, adjacent columns of the plurality of columns are separated by a distance between 1.5 and 2.5 mm. Optionally, for each of the plurality of conductive members, a first portion of each of the plurality of projections comprises a solder-wettable coating and a second portion of the conductive member comprises an anti-wetting coating. Optionally, the first side of the housing comprises a plurality of standoffs.

As an example embodiment, an electrical connector comprises: a plurality of terminal subassemblies, wherein each of the plurality of terminal subassemblies comprises: an insulative portion having a first side; a column comprising a plurality of terminals held within the insulative portion, wherein: each of the plurality of terminals comprises a tail extending from the insulative portion at the first side, a mating contact portion extending from the insulative portion and an intermediate portion, joining the tail and the mating contact portion, and for each of the plurality of terminals, the intermediate portion is held by the insulative portion; a plurality of solder balls coupled to respective ones of the tails of the plurality of terminals at the first side; and at least one planar conductive member extending parallel to the column, wherein the planar conductive member comprises a plurality of projections, extending from the planar conductive member adjacent the first side.

Optionally, each of the plurality of projections is configured for connection to a ground structure of a printed circuit board via solder when the electrical connector is mounted to a surface of a printed circuit board with the first side of the insulative portion facing the surface of the printed circuit board. Optionally, the edge of each of the at least one planar conductive member is adjacent the first side, and the plurality of projections comprise pins extending perpendicular to the first side. Optionally, the plurality of solder balls extends beyond the first side by a first distance; and each of the at least one planar conductive member extends beyond the first side by a second distance, greater than the first distance. Optionally, the second distance is configured such that the edges of each of the plurality of conductive elements extend into a slot on a surface of the printed circuit board when the mezzanine connector is mounted to a surface of the printed circuit board with a reflow operation that fuses the plurality of solder balls to pads on the surface of the printed circuit board.

Optionally, each of the plurality of projections extend into corresponding pockets of a plurality of pockets. Optionally, the first side of the housing comprises a plurality of pockets; the tail of each of the plurality of terminals extends into a respective pocket of the plurality of pockets; and the plurality of projections extend into pockets of the plurality of pockets. Optionally, the insulative portion is molded over the intermediate portions of the terminals. Optionally, each of the plurality of projections comprise a first portion of a solder-wettable coating and a second portion of an anti-wetting coating. Optionally, each of the plurality of terminal subassemblies comprises a lossy material that intersects the at least one conductive member in at least one portion of the conductive member. Optionally, the lossy material is electrically coupled to the at least one conductive member. Optionally, the lossy material also intersects the insulative portion of each of the plurality of terminal subassemblies in at least one portion of the insulative portion.

As an example embodiment, an electronic assembly comprises: a printed circuit board, comprising: a surface; a plurality of pads on the surface; and a ground structure within the printed circuit board; and a connector mounted to the surface, the connector comprising: a housing comprising a side facing the surface of the printed circuit board; a plurality of terminals held by the housing, each terminal of the plurality of terminals comprising a tail; a plurality of solder masses between the housing and the surface of the printed circuit board, wherein at least a subset of the plurality of solder masses are attached to the tails of the plurality of terminals so as to couple tails of the plurality of terminals to respective pads of the plurality of pads; and a plurality of conductive members mechanically coupled to the housing and disposed between at least the tails of sets of terminals of the plurality of terminals, wherein: the plurality of conductive members each comprises a plurality of projections extending into the space between the side of the housing and the surface of the printed circuit board; and the plurality of projections are electrically coupled to the ground structure within the printed circuit board through solder masses of the plurality of solder masses.

Optionally, the plurality of solder masses comprise solder balls. Optionally, the plurality of projections of the plurality of conductive members extend from the housing into a space between the side of the housing and the surface of the printed circuit board. Optionally, each of the plurality of conductive members comprises an edge and the plurality of projections of each of the plurality of conductive members extends from the edge. Optionally, the printed circuit board comprises a plurality of pads coupled to the ground structure within the printed circuit board; a subset of the plurality of solder masses is mechanically and electrically coupled to: a tail of terminal of the plurality of terminals, a projection of the plurality of projections, and a pad of the plurality of pads coupled to the ground structure within the printed circuit board.

Optionally, the printed circuit board comprises a plurality of pads coupled to the ground structure within the printed circuit board; the plurality of solder masses is a first plurality of solder masses; the electronic assembly further comprises a second plurality of solder masses; the plurality of projections of the plurality of conductive members comprise J leads and are fused to the plurality of pads coupled to the ground structure within the printed circuit board via solder masses of the second plurality of solder masses.

Optionally, the printed circuit board is a first printed circuit board; the connector is a first connector; the electronic assembly comprises: a second printed circuit board, parallel to the first printed circuit board; a second connector mounted to the second printed circuit board and mated to the first connector, wherein the first printed circuit board and the second printed circuit board are separated by a distance between 3 mm and 6 mm.

Optionally, a conductive member of the first connector is electrically coupled to a lossy material of the second connector. Optionally, the lossy material of the second connector is electrically coupled to a conductive member of the second connector connected to a ground layer of the PCB. Optionally, the lossy material of the second connector is electrically coupled to the conductive member of the second connector by intersecting the conductive member in at least one portion of the conductive member. Optionally, each of the plurality of projections comprise a first portion of a solder-wettable coating and a second portion of an anti-wetting coating.

As an example embodiment, a connector configured to be electrically coupled to a printed circuit board (PCB) with a hybrid attachment, comprises: a first and second plurality of signal terminals, wherein the first and second plurality of signal terminals are configured to be electrically connected to traces of a PCB using solder balls so as to form a ball gate array (BGA) termination; and a shield between the first and second plurality of signal terminals, wherein the shield comprises one or more pins configured to be inserted into one or more holes of the PCB.

Optionally, the one or more pins of the shield are configured to be electrically connected to a ground layer of the PCB through the holes. Optionally, the connector further comprises a housing, wherein the shield is disposed within a slot of the housing. Optionally, the first and second plurality of signal terminals comprise differential signal pairs. Optionally, the housing is an insulative housing. Optionally, the signal terminals of the first plurality of signal terminals are arranged in a first column and the signal terminals of the second plurality of signal terminals are arranged in a second column, parallel to the first column.

As an example embodiment, a printed circuit board (PCB) configured to be electrically coupled with a connector, comprises: a first and second plurality of signal pads, wherein the first and second plurality of signal pads are configured to be electrically connected to signal terminals of the connector using ball gate array (BGA) termination; and a plurality of holes provided between the first and second plurality of pads, wherein the plurality of holes are configured to receive a plurality of corresponding pins of a shield of the connector.

Optionally, the PCB further comprises a slot, and wherein the plurality of holes are provided within the slot. Optionally, the PCB comprises a ground layer, and wherein one or more pins of a shield of a connector are configured to be electrically connected to the ground layer of the PCB. Optionally, the signal pads of the first plurality of signal pads are arranged in a first column and the pad signal terminals of the second plurality of pad signal terminals are arranged in a second column, parallel to the first column. Optionally, the holes have a drill size between 9 mils and 13 mils. Optionally, the holes have a drill size of around 11 mils. Optionally, the holes have a drill size that is at least 25% larger than the diameter of the one or more pins.

As an example embodiment, a connector comprises: signal terminals configured to be electrically connected to a printed circuit board; wherein the connector is configured to be mounted to a surface of the printed circuit board; and a shield with an edge configured to be below the surface of the printed circuit board, wherein the shield is configured for electrical connection to a ground structure of the printed circuit board.

Optionally, the connector is mounted using a soldering operation. Optionally, the connector is mounted using J-leads that are configured to attach to the printed circuit board using surface mount soldering. Optionally, the connector is mounted using a ball grid array at a mounting interface of the connector. Optionally, the signal terminals are configured to be electrically connected to pads on the printed circuit board. Optionally, the signal terminals are configured to be electrically connected to traces of the printed circuit board.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

1-51. (canceled)

52. A connector configured to be electrically coupled to a printed circuit board (PCB) with a hybrid attachment, the connector comprising:
a first and second plurality of signal terminals, wherein the first and second plurality of signal terminals are configured to be electrically connected to traces of a PCB using solder balls so as to form a ball grid array (BGA) termination; and
a shield between the first and second plurality of signal terminals, wherein the shield comprises one or more pins configured to be inserted into one or more holes of the PCB.

53. The connector of claim 52, wherein the one or more pins of the shield are configured to be electrically connected to a ground layer of the PCB through the holes.

54. The connector of claim 52, further comprising a housing, wherein the shield is disposed within a slot of the housing.

55. The connector of claim 52, wherein the first and second plurality of signal terminals comprise differential signal pairs.

56. The connector of claim 54, wherein the housing is an insulative housing.

57. The connector of claim 52, wherein the signal terminals of the first plurality of signal terminals are arranged in a first column and the signal terminals of the second plurality of signal terminals are arranged in a second column, parallel to the first column.

58. A printed circuit board (PCB) configured to be electrically coupled with a connector, the PCB comprising:
a first and second plurality of signal pads, wherein the first and second plurality of signal pads are configured to be electrically connected to signal terminals of the connector using ball grid array (BGA) termination; and
a plurality of holes provided between the first and second plurality of pads, wherein the plurality of holes are configured to receive a plurality of corresponding pins of a shield of the connector.

59. The PCB of claim 58, further comprising a slot, and wherein the plurality of holes are provided within the slot.

60. The PCB of claim 58, wherein the PCB comprises a ground layer, and wherein one or more pins of a shield of a connector are configured to be electrically connected to the ground layer of the PCB.

61. The PCB of claim 58, wherein the signal pads of the first plurality of signal pads are arranged in a first column and the pad signal terminals of the second plurality of pad signal terminals are arranged in a second column, parallel to the first column.

62. The PCB of claim 58, wherein the holes have a drill size between 9 mils and 13 mils.

63. The PCB of claim 58, wherein the holes have a drill size of around 11 mils.

64. The PCB of claim 58, wherein the holes have a drill size that is at least 25% larger than the diameter of the plurality of pins.

65. A connector, comprising:
signal terminals configured to be electrically connected to a printed circuit board;
wherein the connector is configured to be mounted to a surface of the printed circuit board; and
a shield with an edge configured to be below the surface of the printed circuit board when the connector is mounted to the surface such that the shield is electrically connected to a ground structure of the printed circuit board below the surface.

66. The connector of claim 65, wherein the connector is mounted using a soldering operation.

67. The connector of claim 65, wherein the connector is mounted using J-leads that are configured to attach to the printed circuit board using surface mount soldering.

68. The connector of claim 65, wherein the connector is mounted using a ball grid array at a mounting interface of the connector.

69. The connector of claim 65, wherein the signal terminals are configured to be electrically connected to pads on the printed circuit board.

70. The connector of claim 65, wherein the signal terminals are configured to be electrically connected to traces of the printed circuit board.
